(19) United States
(12) Patent Application Publication
(10) Pub. No.: US 2006/0207394 A1
(43) Pub. Date: Sep. 21, 2006

(54) Apparatus and method for repairing a vibration attenuator for a lathe

(76) Inventor: David W. Coffman, Richmond, VA (US)

Correspondence Address: John H. Thomas, P.C., 536 Granite Avenue, Richmond, VA, 23226, US

(21) Appl. No.: 11/082,270

(22) Filed: Mar. 17, 2005

(51) Int. Cl. B23B 3/00

(52) U.S. Cl. 82/1.11; 82/163

(57) ABSTRACT

The invention relates to an apparatus and method for repairing a vibration attenuator used with a lathe wherein a lathe includes a cutter chassis, a lathe arbor assembly, and a piece of equipment to be machined mounted on said lathe arbor assembly. The lathe has at least one cutting tool supported by the cutter chassis for cutting or resurfacing the mounted equipment. A vibration attenuator dampens the natural vibrations caused by the lathing operation via opposing dampening pads that the attenuator holds against the equipment. The dampening pads' equipment-engaging surfaces deteriorate during the operation of said lathe. A repair pad is fastened to at least one of the dampening pads following the excessive deterioration of at least one of the equipment-engaging surfaces. A spring connecting the arms of the attenuator may also be replaced.

### FIELD OF THE INVENTION

The present invention relates, in general, to an apparatus and method for repairing a vibration attenuator used with a lathe. The repair kit of the present invention consists of an adhesive and a repair pad and, if necessary, a replacement spring.

### BACKGROUND OF THE INVENTION

Most present day vehicles employ a disc brake system for slowing or stopping the vehicle. These systems include a disc brake rotor that is frictionally engaged by one or more brake pads located on a brake caliper. A motor, hydraulic system, or the like is used to variably actuate the caliper, effectively pushing the pad(s) against the rotor. The friction between the brake pad and brake rotor slows the vehicle. Obviously, the friction generated by these systems necessitates that both the pads and rotors must be replaced periodically.

Brake rotors generally sustain wear for a longer period of time than the brake pads. However, the rotors may be unevenly worn before the completion of their serviceable life. For instance, when the friction between the pad and brake is not uniformly distributed, a pattern of circumferentially arranged ridges or valleys is etched onto the face of the rotor. This leads to premature pad wear and reduces maximum braking friction due to the reduction in surface area contact. It is also possible to warp the rotors because of material defects or uneven wear. Warped rotors reduce braking efficiency, which is dangerous, while providing undesirable feedback to the vehicles drivers or passengers. Often, worn rotors can be resurfaced or machined in order to extend their serviceable life.

The rotors, or brake disks, are resurfaced or machined via a disk brake lathe. In use, the rotor is mounted on a rotating shaft and a cutting tool(s) is placed against the unevenly worn surface. Because brake calipers generally apply frictional force to both sides of the rotor, the lathe's chassis supports a pair of tools that engage the rotor's opposing sides. The tools resurface the rotor as it rotates on the shaft.

The tools' cutting action may cause the rotor to vibrate. In order to ensure a suitably planar surface, vibration attenuators have been developed. These attenuators employ dampening or friction pads mounted on a generally U-shaped holder. The holder naturally biases the pads together and/or a spring is provided that connects the holder's two arms and draws the pads together. The pads are secured on the holder by inserting the ends of the arms into the pads. Of course, other methods for securing the pads are possible, including molding the pads directly onto the arms. Some attenuators are also designed so that there is a physical connection between the attenuator and the cutting tools. This connection ensures that a sufficient force between the dampening pads and the rotor by coordinating the movement of the tools with the dampening pads as the cutting tools reduce the width of the rotor.

All dampening pads wear out over time and must be replaced. When sufficiently worn, the end of the attenuator arm will be exposed through the rotor-contacting surface of the pad. The exposed arm might come into contact with the rotor, damaging it. This means the pads must be monitored by the operator or by an electronic system, which is either inefficient and potentially dangerous or needlessly complex and expensive. The current, wasteful practice is to dispose of the entire attenuator, including the pad and/or spring assemblies, whenever one or more of the pads becomes too worn.

Lathes used in other applications also require vibration attenuators. As such, they suffer from the same problems of having to monitor the dampening pads, premature disposal of the attenuator due to wear on a pad, and the expense and time involved in replacing an attenuator. An apparatus and method for repairing the attenuator's pads would reduce costs and increase efficiency for a wide range of lathing applications.

As such, there is a need for an inexpensive and efficient apparatus and method to extend the life of vibration attenuators used with lathes, such as a disk brake lathe. A repair kit in accordance with the present invention would reduce monitoring and replacement costs, minimize damage to the item mounted on the lathe, and extend the life of vibration attenuators by repairing the attenuator's dampening pads.

### SUMMARY OF THE INVENTION

In accordance with the present invention, a repair kit and repair method is provided which allows for the repair of dampening pads located on a lathe's vibration attenuator. The repair kit includes an adhesive and a repair pad; an optional replacement spring may be included.

The repair kit of the present invention is intended for a lathe's vibration attenuator, the lathe including a cutting head assembly and at least one cutting tool. A piece of equipment subject to cutting or resurfacing is mounted on a lathe's rotating shaft (also known as a lathe arbor assembly). A vibration attenuator is used to dampen the vibrations in the subject equipment that naturally occur as part of the lathing operation. The attenuator includes a pair of dampening pads held in an equipment-engaging position. The pads are secured to the end of the attenuator, which is typically U-shaped. The attenuator's arms, and/or a spring connecting the respective arms, tend to bias the pads towards each other. In this manner, a sufficient pressure between the pads and the piece of equipment subject to cutting is maintained. The pressure on the opposing surfaces of the subject equipment supports the piece of equipment and reduces vibration.

In greater detail, and in a preferred embodiment of the invention, a pair of generally square, rectangular or rectilinear dampening pads are used to dampen vibrations in a piece of equipment mounted on a lathe. The dampening pads are secured over the two ends of the generally U-shaped attenuator. The equipment-engaging surface of the dampening pad is the dampening pad material located between the equipment to be cut and the arm inserted into the pad and bounded by the sidewalls of the pad. The volume of the equipment-engaging surface of the dampening pads is reduced due to friction during the lathe's operation. Eventually, the portion of the attenuator arm that is internal to the dampening pad is exposed, or the equipment-engaging surface deteriorates beyond an acceptable level. To prevent damage to the equipment mounted on the lathe, the pads must be replaced or repaired before the arm of the attenuator is exposed.

The present invention provides a repair pad that roughly matches the dimensions of the equipment-engaging surface of the dampening pad. In other words, the repair pad's outline mimics the outline of the dampening pad, and it is about as thick as the dampening pad's equipment-engaging surface. When one or more of the dampening pads is too worn for continued use, a lathe operator, mechanic or technician would secure the repair pad to the dampening pad in place of the now worn equipment-engaging surface. The repair pad may be made of any material, but in at least one preferred embodiment, the repair pad is formed from the same material as the dampening pad. In another preferred embodiment, non-organic asbestos from Reddaway, Inc. of New Jersey is used. Reddaway sells such asbestos as Reddaway Part Number 622.

The repair pad is secured to the dampening pad by any fastener known in the art. In a preferred embodiment, an adhesive is used to bond the repair pad to the dampening pad. The attenuators often include springs that pull the arms of the U-shaped attenuator towards each other. This increases the pressure between the dampening pads and mounted equipment. A replacement spring may be included as part of the repair kit of the present invention.

A preferred method for applying the repair pad of the present invention involves mounting a piece of equipment to be cut or resurface on a lathe arbor assembly. The dampening pads are placed in an equipment-engaging position. The arbor assembly rotates the equipment, which eventually wears down the equipment-engaging surface of the dampening pads. After a threshold amount of wear has occurred, a repair pad is fastened to the exposed face of the dampening pad. This may be accomplished by means of an adhesive layer created between the dampening pad and the repair pad wherein the adhesive bonds the pads together. It is envisioned that the adhesive may be placed on one or both pads that are to be joined. As one skilled in the art would appreciate, the attenuator can be removed during the repair process or it can remain on or connected to the lathe chassis as the dampening pads are repaired. The operator may also replace attenuator spring 38, if included, as necessary.

In summary, a repair kit and repair method incorporating a fastener, repair pad, and optional replacement spring in accordance with the present invention efficiently addresses various problems associated with prior art lathe vibration attenuators, and the kit and method comprise a commercially advantageous product. A repair kit in accordance with the present invention reduces monitoring and replacement costs, minimizes potential damage to the equipment mounted on the lathe, and extends the life of vibration attenuators by repairing the attenuator's dampening pads. Clearly, the ability to repair the dampening pads in a lathe's vibration attenuator is a cost advantage in comparison to the expense of replacing the entire attenuator. In addition, if one pad wears prematurely, it is now possible to extend the serviceable life of the attenuator.

### BRIEF DESCRIPTION OF DRAWINGS

The foregoing, and additional objects, features, and advantages of the present invention will become apparent to those of skill in the art from the following detailed description of a preferred embodiment thereof, taken in conjunction with the accompanying drawings, in which:

FIG. 1 is a perspective view of a lathe with a vibration attenuator as known in the prior art;

FIG. 2 is a perspective view of a generally U-shaped vibration attenuator for a lathe as known in the prior art wherein a spring is included to bias the ends of the attenuator towards each other;

FIG. 3 is a top down view of the of the vibration attenuator of FIG. 2;

FIG. 4 is a top down, cut-away view of the known attenuator's dampening pads engaging equipment mounted on a lathe;

FIG. 5 is a top down, cut-away view of the known attenuator's dampening pads engaging equipment mounted on a lathe where in the pads have worn away their respective equipment-engaging surfaces;

FIGS. 6A-6C illustrate a cut-away progression of dampening pads from unused condition, to worn condition, to a repaired condition, respectively, in accordance with the present invention;

FIG. 7 is a perspective view a repair pad and worn dampening pad in a spaced relationship in accordance with a preferred embodiment of the present invention; and

FIGS. 8A-8C illustrate side views of additional repair pad profiles in accordance with the present invention.

### DETAILED DESCRIPTION OF THE APPLICATION

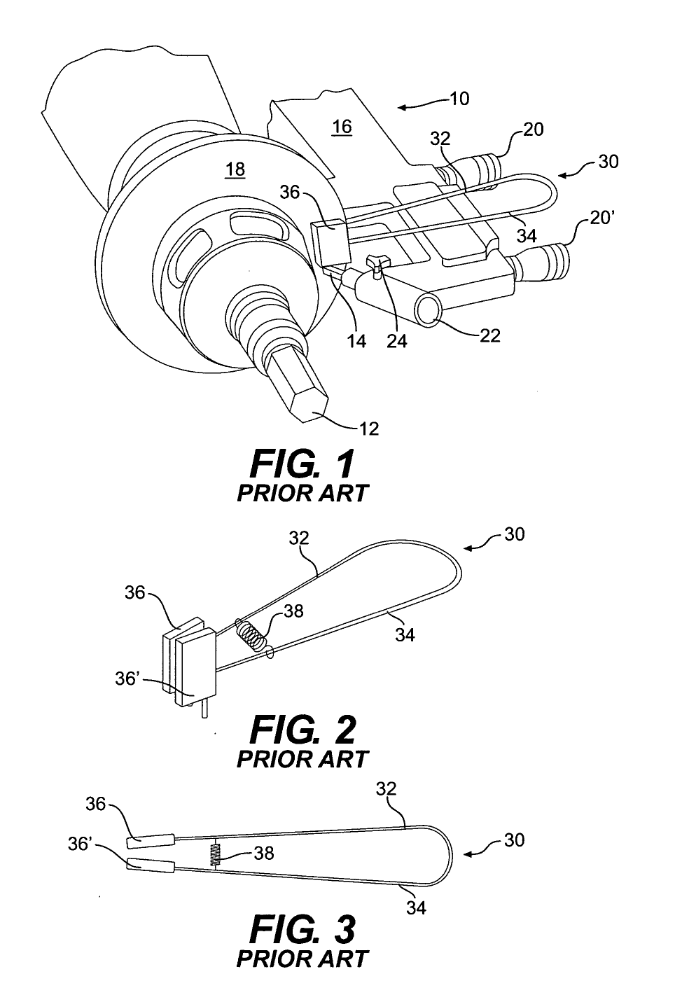

Turning now to a more detailed description of the present invention, there is illustrated in FIGS. 1-5 embodiments of known lathe vibration attenuators necessary to understand the applicant's invention. The construction and operation of lathes in general will not be described in extensive detail inasmuch as such details are known to those skilled in the art. Moreover, the lathe illustrated is merely exemplary. Therefore, the present invention need not be associated with the illustrated prior art embodiments as it is adaptable for operation with any lathe vibration attenuator.

In general, a lathe 10 includes a lathe arbor assembly 12, at least one cutting tool 14, and a cutter chassis 16. A piece of equipment 18 to be cut or resurfaced is mounted on arbor assembly 12, which rotates the mounted equipment during the lathe's operation. Equipment 18 can be any element that needs resurfacing or cutting, although the embodiment illustrated by FIG. 1 presents equipment 18 as a brake rotor. As it is further known in the art, chassis 16 may include adjustment knobs 20, 20′ that can be used to selectively move cutting tool(s) 14 along the face of rotor 18. A cutter holder 22 secures cutting tool 14 while a cutter knob 24 permits cutting tool 14 to be selectively extended or retracted into holder 22. The adjustment mechanism of cutter knob 24 permits an operator to set the desired cutting depth. Although only one cutting tool 14, cutter holder 22, and cutter knob 24 are illustrated in FIG. 1, each element is generally provided in a pair so as to resurface both sides of rotor 18. The above elements are known in the art and do not require further explanation.

A vibration attenuator 30 is generally U-shaped with a first arm and second arm 32, 34 located to either side of equipment 18. The respective ends of the first and second arms terminate within dampening pads 36, 36′ (see FIGS. 2-5). Attenuator 30 provides a natural biasing force to arms 32, 34 that moves the arms towards each other. In other words, the arms are not, by nature, parallel although different geometries are possible depending on the specific application of the lathe. A spring 38 can also be included to increase the inward bias force. The spring can be attached to attenuator 30 by any means known in the art such as hooks, loop ends, or the like. Typically, the springs are not permanently attached to the attenuator.

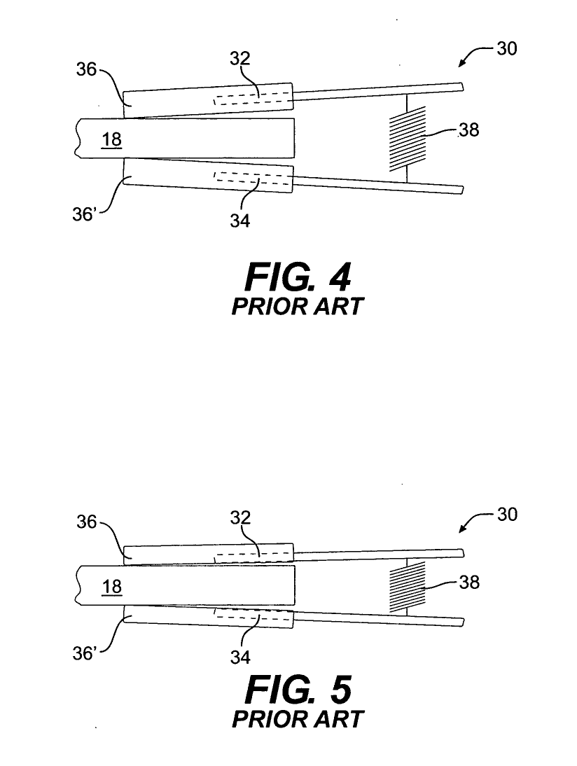

Turning now to FIGS. 4 and 5, pads 36, 36′ are illustrated in an equipment-engaging position. Depending on the application and design of the attenuator, pads 36, 36′ may be flush against the face of equipment 18. The illustrated gap between the pads and rotor 18 reinforces the angular relationship of arm 32 to arm 34. The actual angular relationship of the pads to equipment 18 will be determined by a number of factors that are not relevant to the present invention.

Again, arms 32, 34 terminate within pads 36, 36′ and compel the pads against equipment 18. The pads are mounted on the distal ends of the arms by any means known to one skilled in the art. For instance, the pads, which are generally formed of a friction resistant material, can be made to include an aperture into which the attenuator arms can be inserted. It is also foreseeable that the arms could penetrate the sidewalls of the pads. In yet another alternative, the pads could be molded directly onto the ends of the arms. In any event, the current practice is to construct the attenuator and dampening pad assembly so that the attenuator terminates within the dampening pads.

Attenuator 30 may or may not be in physical connection with the lathe chassis 16 or cutting tools 14. It is a known practice to rest the attenuator 30 upon the chassis 16. From the perspective of FIG. 1, arbor assembly 12 rotates equipment 18 clockwise so that chassis 16 would act as a brace for attenuator 30.

FIG. 4 presents the dampening pads in an initial equipment-engaging, or rotor-engaging, position while FIG. 5 illustrates the pads after a period of operating the lathe has led to the removal of a distinct volume of the dampening pads. In FIG. 5, attenuator arms 32, 34 are nearly exposed to equipment 18. As the attenuators are generally made of metal, the arms could potentially damage the opposing sides of rotor 18 were they to be fully exposed. Other materials are suitable for constructing the attenuator although metal is the preferred choice. Also known to one skilled in the art is the spring 38. In FIG. 4, spring 38 is pulling the arms together so that the unworn pads exert pressure on opposing sides of the rotor. In FIG. 5, it is also evident that spring 38 has contracted as pads 36, 36′ wear away. In this worn state, the pressure between the pads and the rotor may be reduced, thereby diminishing the efficacy of attenuator 30.

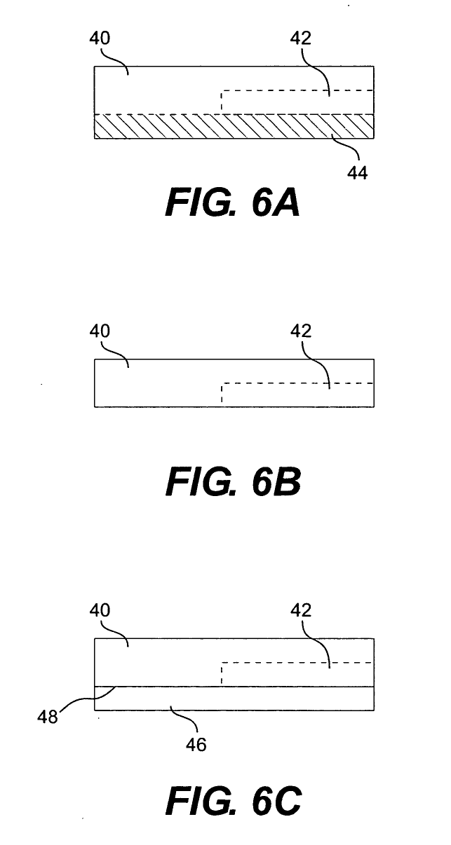

FIGS. 6A-6C illustrate the operating progression of the attenuator dampening pads in accordance with the present invention. First, in FIG. 6A, an unworn dampening pad 40 illustrated. The unworn pad is supported upon an internally placed attenuator arm 42, as described above. An equipment-engaging surface of unworn dampening pad 40 is identified as element 44. Equipment-engaging surface 44 is defined as the volume of dampening pad material located between the equipment to be cut and the arm inserted into the pad and further bounded by the sidewalls of the pad. The dampening pads' cross-sectional shape will vary given the application or attenuator manufacturer. The total volume of equipment-engaging surface 44 is reduced due to friction during the lathe's operation. Eventually, the portion of attenuator arm 42 that is internal to the dampening pad is exposed or is nearly exposed. As illustrated in FIG. 6B, equipment-engaging surface 44 has been entirely removed due to friction.

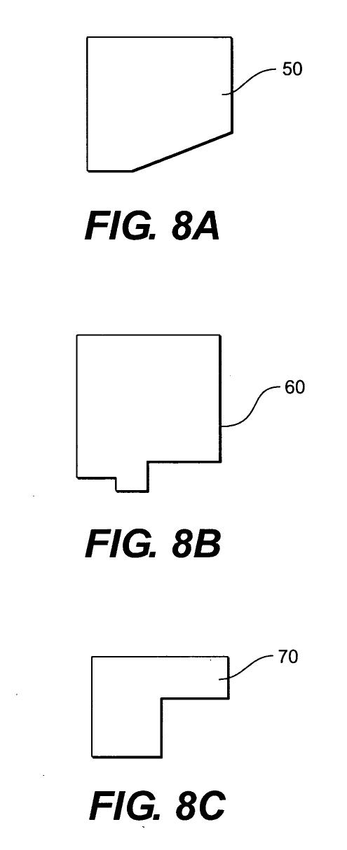

A repair pad, identified as element 46 in FIG. 6C, is a clear improvement over the prior art practice of disposing of the entire attenuator assembly when one or both of the equipment-engaging surfaces become excessively worn. Although illustrated as roughly rectangular, dampening pads 36, 36′ can be made from any number of geometries. In a preferred embodiment, repair pad 46 is constructed so as to replicate the shape and volume of a corresponding equipment-engagement surface. FIGS. 8A-8C illustrate a few examples of known attenuator pad profiles. It is envisioned that a repair pad in accordance with the present invention would be made into one or more of these shapes or would take the shape of other attenuator pads not specifically illustrated. The profiles of the illustrated attenuator pads would include means to insert an attenuator arm. It may also be possible to include additional features that may have a functional use with the lathe. A repair pad in accordance with the present invention is not limited to the specific illustrated attenuator pad profiles.

In addition to the repair pad's outline mimicking the outline of the original dampening pad, and repair pad 46 provides the same, or about the same, thickness as the dampening pad's equipment-engaging surface 44. Many attenuator pads are ⅜ of an inch thick with the attenuator arms being roughly ⅛ of an inch thick. The arms are centered in the attenuator pads meaning the attenuator pads provide ⅛ of an inch thickness from the equipment-engaging surface to the internal attenuator support or arm. The repair pad will substantially conform to the dimensions of the equipment-engaging surface before that surface is deteriorated due to friction.

When one or more of the dampening pads is too worn for continued use, a lathe operator, mechanic or technician would secure repair pad 46 to a dampening pad in place of the now worn or eliminated equipment-engaging surface 44. The repair pad may be made of the same material used to make the dampening pad. Commonly, attenuator pads are made of non-organic asbestos. Reddaway, Inc. of New Jersey, for instance, makes non-organic asbestos products (sold as Part Number 622). The exact material may vary depending the intended application. While dampening pads are generally formed from friction resistant materials, repair pad 46 may be made of any suitable material or combination of materials.

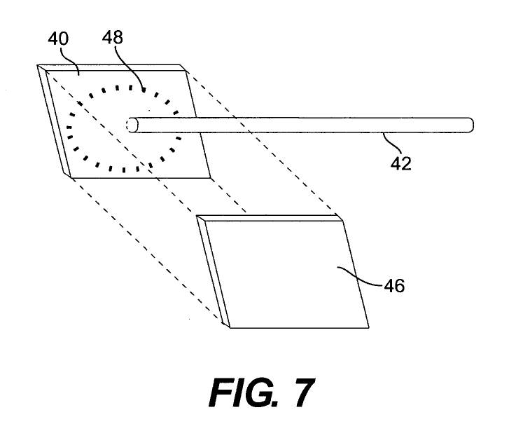

Repair pad 46 is secured to dampening pad 40 via any fastening method available. In a preferred embodiment, an adhesive layer 48 bonds repair pad 46 to dampening pad 40. This is further illustrated in the perspective view of FIG. 7 wherein repair pad 46 is shown in spaced relationship with dampening pad 40. Dots of adhesive 48 have been applied to the dampening pad's exposed face 48. Repair pad 46 is then pressed onto the dampening pad's exposed face, bonding the two pads together. The repair kit's adhesive is envisioned as commercially available and packaged glue, such as Super Glue™ from the Super Glue Corporation™. The adhesive must withstand the shear force between the repair pad and dampening pad during operation of the lathe. A number of adhesive options are available.

It is further envisioned that the adhesive could be applied to either pad. The lather operator may determine the exact coverage and volume of adhesive. The amount, location, and spacing of the adhesive will vary based on the specific application of the lathe, the lathe operator's preferences, or other factors.

A repair kit in accordance with the present invention may also include a replacement spring for spring 38 (see, e.g., FIG. 5). The replacement spring (not shown) is secured to the attenuator through commonly used and known methods. For instance, the lathe operator would remove the dampening pads from the attenuator's arms so that loops on the terminal ends of the spring fit over the respective arms. The replacement spring's terminal ends might incorporate hooks that secure to the attenuator arms without disassembling the attenuator. Other options are also available and are readily apparent to one skilled in the art.

A preferred method for applying the repair pad of the present invention involves mounting a piece of equipment 18 to be cut on a lathe arbor assembly 12. Pads 36, 36′ are placed in an equipment-engaging position. The arbor assembly rotates the equipment, which eventually wears down the equipment-engaging surface of the dampening pads. A repair pad is fastened to the dampening pad's newly exposed face. The step of fastening the pads together can be accomplished via an adhesive. Specifically, after a threshold amount of wear has occurred, an adhesive layer is created between the dampening pad and a repair pad. It is envisioned that the adhesive may be placed on one or both pads that are to be joined. As one skilled in the art would appreciate, the attenuator can be removed during the repair process or it can remain on or connected to the lathe chassis as the dampening pads are repaired. The operator may also replace attenuator spring 38, if included, as necessary.

Although the present invention has been described in terms of a preferred embodiment, it will be understood that numerous variations and modifications may be made without departing from the invention. Thus, for example, the repair pad can take numerous shapes other than the generally rectangular shape illustrated. It can also be formed from numerous materials and fastened to the dampening pads by known fasteners, including heat bonding, welding, screws or the like. Furthermore, the shape of the attenuator can vary so long as dampening pads are held in an equipment-engaging position. Additional embodiments will become apparent to one skilled in the art. Thus, it is to be understood that within the scope of the appended claims, the invention may be practiced otherwise than as specifically described above.

What is claimed is:

1. A repair system for a lathe vibration attenuator, comprising:
a lathe including a cutter chassis and a lathe arbor assembly;
a piece of equipment to be machined mounted on said lathe arbor assembly;
at least one cutting tool supported by said cutter chassis, said at least one cutting tool selectively placed in physical contact with said equipment;
a vibration attenuator, said attenuator including a first dampening pad and a second dampening pad, said first and said second dampening pads held by said attenuator in an equipment-engaging position;
each of said first and said second dampening pads providing equipment-engaging surfaces subject to deterioration during the operation of said lathe; and
wherein at least one repair pad is fastened to at least one of said first and said second dampening pads following the deterioration of at least one of said equipment-engaging surfaces.

2. The repair system of claim 1, wherein said at least one repair pad is fastened to at least one of said first and said second dampening pads via an adhesive.

3. The repair system of claim 1, further comprising a spring, said spring secured to said vibration attenuator in order to increase the contact pressure between said equipment and said first and said second dampening pads, and wherein a replacement spring is provided with said at least one repair pad.

4. The repair system of claim 2, further comprising a spring, said spring secured to said vibration attenuator in order to increase the contact pressure between said equipment and said first and said second dampening pads, and wherein a replacement spring is provided with said at least one repair pad and with said adhesive.

5. The repair system of claim 1, wherein each of said first and said second dampening pads include respective equipment-engaging surfaces, said at least one repair pad of substantially the same shape and volume as one of said equipment-engaging surfaces.

6. A method of using a repair system for a lathe vibration attenuator, comprising:
mounting a piece of equipment to be cut on a lathe arbor assembly;
placing at least one dampening pad of a vibration attenuator in an equipment-engaging position;
rotating the equipment to perform a lathing operation, an equipment-engaging surface of said at least one dampening pad deteriorating during operation; and
fastening at least one repair pad to said at least one dampening pad after a threshold amount of deterioration has occurred.

7. The method of claim 6 wherein fastening at least one repair pad to said at least one dampening pad comprises forming an adhesive layer between the respective pads.

8. The method of claim 6 further comprising the step of replacing a vibration attenuator spring with a replacement spring.

9. The method of claim 7 further comprising the step of replacing a vibration attenuator spring with a replacement spring.

10. A repair kit for a lathe vibration attenuator including a first dampening pad and a second dampening pad, each of said first and said first and said second dampening pads providing equipment-engaging surfaces subject to deterioration during the operation of a lathe, the repair kit comprising:
a repair pad adapted to be fastened to at least one of said first and said second dampening pads following the deterioration of at least one of said equipment-engaging surfaces.

11. The repair kit of claim 10, wherein said at least one repair pad is fastened to at least one of said first and said second dampening pads with an adhesive.

12. The repair kit of claim 10, further comprising a replacement spring, said spring securable to said vibration attenuator in order to increase the contact pressure between said equipment and said first and said second dampening pads.

13. The repair kit of claim 11, further comprising a replacement spring, said spring securable to said vibration attenuator in order to increase the contact pressure between said equipment and said first and said second dampening pads.

14. The repair kit of claim 10, wherein said first and said second dampening pads include respective equipment-engaging surfaces, said at least one repair pad of substantially the same shape and volume as one of said equipment-engaging surfaces.

15. A method of using a repair kit for a lathe vibration attenuator, the attenuator having at least one dampening pad and an equipment-engaging surface of said at least one dampening pad, the method comprising the steps of:
providing a repair pad of substantially the same shape and volume as the equipment-engaging surface; and
fastening the repair pad to said at least one dampening pad after a threshold amount of deterioration has occurred.

16. The method of claim 15 wherein fastening the repair pad to said at least one dampening pad comprises forming an adhesive layer between the respective pads.

17. The method of claim 15 further comprising the step of replacing a vibration attenuator spring with a replacement spring.

18. The method of claim 16 further comprising the step of replacing a vibration attenuator spring with a replacement spring.
